(19) United States
(12) Patent Application Publication
(10) Pub. No.: US 2008/0022959 A1
(43) Pub. Date: Jan. 31, 2008

(54) Method for Starting an Internal Combustion Engine and Engine Control Device

(75) Inventor: Matthias Moras, Stuttgart (DE)

Correspondence Address: LERNER GREENBERG STEMER LLP, P O BOX 2480, HOLLYWOOD, FL, 33022-2480, US

(73) Assignee: DR. ING. H.C. F. PORSCHE AKTIENGESELLSCHAFT, Weissach (DE)

(21) Appl. No.: 11/828,574

(22) Filed: Jul. 26, 2007

(30) Foreign Application Priority Data
Jul. 26, 2006 (DE) DE102006034540.1

(51) Int. Cl. F02D 41/06

(52) U.S. Cl. 123/179.16

(57) ABSTRACT

In a method for starting an internal combustion engine with direct injection of the fuel, an injection into at least one of the cylinders is omitted in a directed manner during at least one cylinder operating cycle of the internal combustion engine after an event triggering the operation to start the internal combustion engine has occurred and in the presence of at least one predetermined operating condition.

### CROSS-REFERENCED TO RELATED APPLICATION

This application claims the priority, under 35 U.S.C. § 119, of German application DE 10 2006 034 540.1, filed Jul. 26, 2006; the prior application is herewith incorporated by reference in its entirety.

### BACKGROUND OF THE INVENTION

### Field of the Invention

The invention relates to a method for starting an internal combustion engine. The invention relates, furthermore, to an engine control device.

Internal combustion engines of motor vehicles must be capable of being started reliably under all possible operating conditions after an event triggering an operation to start the internal combustion engine has occurred, without there being the risk that the internal combustion engine stops during the starting operation. In internal combustion engines with direct gasoline injection, this presents difficulties particularly at low ambient temperatures or operating temperatures. Thus, during the operation to start an internal combustion engine with direct gasoline injection at low ambient temperatures, a sharp drop of the injection pressure provided by an injection system may occur below a pressure level which is required for good fuel mixture preparation and/or for introducing the required fuel quantity within the time window available for injection. In this case, the combustion engine may stop during the starting operation. This is a disadvantage.

### SUMMARY OF THE INVENTION

It is accordingly an object of the invention to provide a method for starting an internal combustion engine and an engine control device which overcome the above-mentioned disadvantages of the prior art methods and device of this general type, in which there is no risk that the internal combustion engine stops during a starting operation. Furthermore, the problem on which the invention is based is to provide a corresponding engine control device.

With the foregoing and other objects in view there is provided, in accordance with the invention, a method for starting an internal combustion engine having cylinders with direct injection of fuel. The method includes omitting an injection into at least one of the cylinders in a directed manner during at least one cylinder operating cycle of the internal combustion engine after an event triggering an operation to start the internal combustion engine has occurred and in a presence of at least one predetermined operating condition.

According to the invention, after the event triggering the operation to start the internal combustion engine has occurred and in the presence of at least one predetermined operating condition, the injection into at least one of the cylinders is omitted in a directed manner during at least one cylinder operating cycle of the internal combustion engine. The situation can thereby be avoided where the internal combustion engine stops during the starting operation even under unfavorable operating conditions.

In terms of the method according to the invention, when at least one predetermined operating condition is present after an event triggering the starting operation has occurred, an injection into at least one of the cylinders is omitted in a directed manner during at least one cylinder operating cycle in order to start the internal combustion engine. The balance between the injected and the after fed fuel quantity can thereby be improved during the starting operation, so that the injection pressure or fuel pressure provided by an injection system does not fall so sharply, even under unfavorable operating conditions that there is the risk that the internal combustion engine stops during the starting operation.

Preferably, when the event triggering the operation to start the internal combustion engine occurs and in the presence of the or each predetermined operating condition, an injection into at least one of the cylinders is omitted during at least two successive cylinder operating cycles, in this case an injection being carried out, specifically preferably with an increased fuel quantity, for those cylinders for which an injection is omitted during a cylinder operating cycle, in the cylinder operating cycle which immediately follows this.

Other features which are considered as characteristic for the invention are set forth in the appended claims.

Although the invention is illustrated and described herein as embodied in a method for starting an internal combustion engine and an engine control device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWINGS

FIG. 1 is a graph illustrating a method, known from practice, for starting an internal combustion engine; and

FIG. 2 is a graph illustrating a method according to the invention for starting an internal combustion engine.

### DETAILED DESCRIPTION OF THE INVENTION

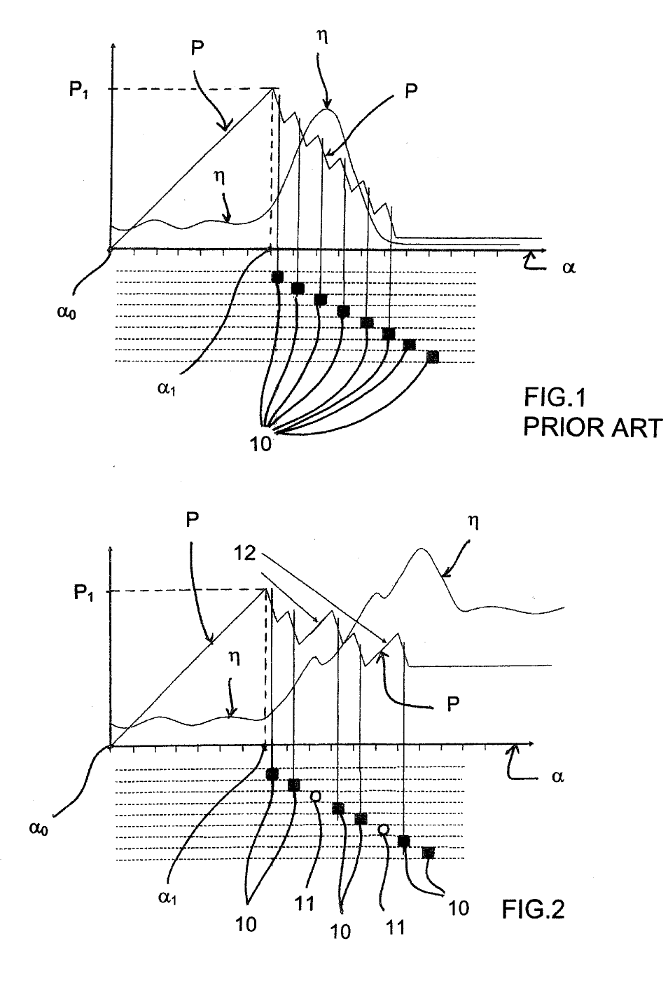

Referring now to the figures of the drawing in detail and first, particularly, to FIG. 1 thereof, there is shown a procedure, known from practice, for starting an internal combustion engine.

FIG. 1 shows a graph in which, on the one hand, an injection pressure P provided by an injection system and, on the other hand, a rotational speed n of the internal combustion engine to be started are illustrated in dependence on a crank angle α.

After an event triggering an operation to start the internal combustion engine has occurred at a crank angle α₀, an injection system of the internal combustion engine builds up an injection pressure or fuel pressure P continuously, until a release pressure P₁ is present at the crank angle α₁. When the release pressure P₁ is reached, the injection of fuel into the individual cylinders of the internal combustion engine then takes place according to a cylinder sequence defined in a cylinder operating cycle, according to FIG. 1 fuel being injected into each of the cylinders of the internal combustion engine in the sequence predetermined by the cylinder operating cycle.

Injection operations are illustrated by small boxes 10 in FIG. 1, each of the small boxes 10 in FIG. 1 corresponding to an operation for injection into a different cylinder of the internal combustion engine. The internal combustion engine to which the graph of FIG. 1 relates is therefore an 8-cylinder internal combustion engine.

According to FIG. 1, the injection pressure P decreases during each injection operation 10. In FIG. 1, the time span between two successive injection operations is not sufficient to compensate for a pressure drop, caused by an injection operation 10, in the injection pressure P. In internal combustion engines with direct gasoline injection, this is the case particularly when the engine has to be started at low ambient temperatures of, in particular, less than minus 20° C.

The result of this in the graph of FIG. 1 is that, even in the first cylinder operating cycle of the 8-cylinder internal combustion engine, to be precise after the third injection operation 10, the injection pressure or fuel pressure P has fallen to an extent such that a sufficient fuel quantity cannot be injected into the cylinders of the internal combustion engine, as a result of which, according to FIG. 1, the rotational speed n of the internal combustion engine falls even after the third injection operation in the first cylinder operating cycle and the internal combustion engine stops after the sixth injection operation 10.

FIG. 2 illustrates with a graph the method according to the invention for starting an internal combustion engine. FIG. 2 illustrates, on the one hand, a fuel pressure or injection pressure P of an injection system and, on the other hand, a rotational speed n of the internal combustion engine in dependence on the crank angle α.

After an event triggering the operation to start the internal combustion engine has occurred at the crank angle α₀, the injection system of the internal combustion engine again builds up the injection pressure P continuously, until the release pressure P₁ is reached at the crank angle α₁. According to FIG. 2, after the event triggering the starting operation has occurred and after the release pressure P₁ is reached, injections into selected cylinders of the internal combustion engine are omitted in a directed manner at least during the first cylinder operating cycle of the internal combustion engine, in FIG. 2 executed injections being illustrated by small boxes 10 and omitted injections by circles 11. Thus, in the exemplary embodiment of FIG. 2, injections are omitted into the cylinders of the internal combustion engine into which the third and the sixth injection would take place according to the cylinder operating cycle.

As may be gathered from FIG. 2, since the third and the sixth injection in the first cylinder operating cycle of the operation to start the internal combustion engine are omitted, the time span between the second and the fourth injection operation and between the fifth and the seventh injection operation is sufficiently long to compensate for the pressure drop, caused by the injection operations, in the injection pressure or fuel pressure P, at least to an extent such that, in each injection operation, a fuel quantity sufficient for starting the internal combustion engine can be injected into the respective cylinders of the internal combustion engine in each case within the available time window. The situation can thereby reliably be avoided where the internal combustion engine stops during the starting operation.

The regions of the starting operation in which the pressure drop, caused by injection operations 10 actually executed, in the fuel pressure or injection pressure P can be at least partially compensated due to omitted injection operations 11 are identified in FIG. 2 by the reference numeral 12.

The directed omission of injection operations in cylinders of the internal combustion engine during at least one cylinder operating cycle after the event triggering the operation to start the internal combustion engine has occurred and after the release pressure is reached does not, in terms of the present invention, take place under all operating conditions, but only when at least one predetermined operating condition is present.

Such operating conditions may be, for example, that the operating temperature or ambient temperature of the internal combustion engine at which the latter is to be started lies below a predetermined limit value. A further operating condition, which may be present additionally or alternatively to the above operating condition, may be that an injection pressure gradient at which the injection pressure P rises between the crank angles α₀ and α₁ lies below a predetermined limit value.

In the simplest case of the method according to the invention, after the event triggering the operation to start the internal combustion engine has occurred and in the presence of a specific operating condition, an injection into at least one of the cylinders of the internal combustion engine is omitted solely during the first cylinder operating cycle, whereas fuel is injected into all the cylinders in the following cylinder operating cycles. The two Tables 1 and 2 below show possible variants for the configuration of the method according to the invention, in which an injection into selected cylinders of the internal combustion engine is omitted solely during the first cylinder operating cycle. According to Table 1, the injection into the third and the sixth cylinder according to the cylinder sequence are omitted in the first cylinder operating cycle, and according to Table 2 the injection into the fourth and the eighth cylinder according to the cylinder sequence are omitted.

TABLE 1

| | Operating cycle | | | | | | | | | | | | | | | | | | | | | | | |
|---|---|---|---|---|---|---|---|---|---|---|---|---|---|---|---|---|---|---|---|---|---|---|---|---|
| | 1 | | | | | | | | 2 | | | | | | | | 3 | | | | | | | |
| Cylinder | 1 | 2 | 3 | 4 | 5 | 6 | 7 | 8 | 1 | 2 | 3 | 4 | 5 | 6 | 7 | 8 | 1 | 2 | 3 | 4 | 5 | 6 | 7 | 8 |
| sequence | | | | | | | | | | | | | | | | | | | | | | | | |
| Injection | X | X | — | X | X | — | X | X | X | X | X | X | X | X | X | X | X | X | X | X | X | X | X | X |

TABLE 2

| | Operating cycle | | | | | | | | | | | | | | | | | | | | | | | |
|---|---|---|---|---|---|---|---|---|---|---|---|---|---|---|---|---|---|---|---|---|---|---|---|---|
| | 1 | | | | | | | | 2 | | | | | | | | 3 | | | | | | | |
| Cylinder | 1 | 2 | 3 | 4 | 5 | 6 | 7 | 8 | 1 | 2 | 3 | 4 | 5 | 6 | 7 | 8 | 1 | 2 | 3 | 4 | 5 | 6 | 7 | 8 |
| sequence | | | | | | | | | | | | | | | | | | | | | | | | |
| Injection | X | X | X | — | X | X | X | — | X | X | X | X | X | X | X | X | X | X | X | X | X | X | X | X |

According to the two Tables 3 and 4 below, injections into cylinders of the internal combustion engine are omitted in a directed manner during the first two cylinder operating cycles. According to Table 3 the injection into the third and the sixth cylinder according to the cylinder sequence are omitted in the first operating cycle and that into the first, the fourth and the seventh cylinder according to the cylinder sequence being omitted during the second cylinder operating cycle. In the variant of Table 4, the injection into the third, the fifth and the seventh cylinder according to the cylinder sequence is omitted during the first operating cycle and that into the first cylinder according to the cylinder sequence is omitted during the second cylinder operating cycle. It follows from this that, for those cylinders for which an injection is omitted during a cylinder operating cycle, an injection is carried out in the cylinder operating cycle which immediately follows this.

TABLE 3

| | Operating cycle | | | | | | | | | | | | | | | | | | | | | | | |
|---|---|---|---|---|---|---|---|---|---|---|---|---|---|---|---|---|---|---|---|---|---|---|---|---|
| | 1 | | | | | | | | 2 | | | | | | | | 3 | | | | | | | |
| Cylinder | 1 | 2 | 3 | 4 | 5 | 6 | 7 | 8 | 1 | 2 | 3 | 4 | 5 | 6 | 7 | 8 | 1 | 2 | 3 | 4 | 5 | 6 | 7 | 8 |
| sequence | | | | | | | | | | | | | | | | | | | | | | | | |
| Injection | X | X | — | X | X | — | X | X | — | X | X | — | X | X | — | X | X | X | X | X | X | X | X | X |

TABLE 4

| | Operating cycle | | | | | | | | | | | | | | | | | | | | | | | |
|---|---|---|---|---|---|---|---|---|---|---|---|---|---|---|---|---|---|---|---|---|---|---|---|---|
| | 1 | | | | | | | | 2 | | | | | | | | 3 | | | | | | | |
| Cylinder | 1 | 2 | 3 | 4 | 5 | 6 | 7 | 8 | 1 | 2 | 3 | 4 | 5 | 6 | 7 | 8 | 1 | 2 | 3 | 4 | 5 | 6 | 7 | 8 |
| sequence | | | | | | | | | | | | | | | | | | | | | | | | |
| Injection | X | X | — | X | — | X | — | X | — | X | X | X | X | X | X | X | X | X | X | X | X | X | X | X |

In terms of the present invention, the number of cylinders into which an injection is carried out during a cylinder operating cycle or for which an injection is omitted in accordance with the method according to the invention can be selected freely. Furthermore, the sequence of the cylinders into which injection is carried out and for which injection is omitted can be selected freely. It is likewise possible, in terms of the present invention, to select freely the fuel quantity which is injected into the cylinders into which injection is carried out.

In this case, preferably, the procedure is such that an injection with an increased fuel quantity is carried out into those cylinders, for which an injection is omitted during a cylinder operating cycle, in the cylinder operating cycle which immediately follows it.

In the case of Table 3, this would mean that, in the second operating cycle, an injection with an increased fuel quantity is carried out into the third and the sixth cylinder, according to the cylinder sequence, for which an injection was omitted in the first cylinder operating cycle. An injection with an increased fuel quantity would then likewise be carried out in the third cylinder operating cycle for the first, the fourth and the seventh cylinder according to the cylinder sequence.

According to an advantageous development, there may be provision for the number and/or sequence of the cylinders, into which an injection is carried out or for which an injection is omitted, and/or for the injection quantity to be injected for those cylinders into which an injection is carried out to be determined in dependence on the or each predetermined operating condition in the presence of which the method according to the invention is implemented. Thus, for example, there may be provision for the method according to the invention to be implemented according to Table 3 when it is implemented on account of the undershooting of a limit value for the ambient temperature. Furthermore, there may be provision for the method according to the invention to be carried out according to Table 4 when it is implemented on account of the undershooting of a limit value for the injection pressure gradient.

1. A method for starting an internal combustion engine having cylinders with direct injection of fuel, which comprises the steps of:
omitting an injection into at least one of the cylinders in a directed manner during at least one cylinder operating cycle of the internal combustion engine after an event triggering an operation to start the internal combustion engine has occurred and in a presence of at least one predetermined operating condition.

2. The method according to claim 1, which further comprises omitting the injection into at least one of the cylinders solely during one cylinder operating cycle after the event triggering the operation to start the internal combustion engine has occurred and in the presence of the at least one predetermined operating condition.

3. The method according to claim 1, which further comprises omitting the injection into at least one of the cylinders during at least two successive cylinder operating cycles after the event triggering the operation to start the internal combustion engine has occurred and in the presence of the at least one predetermined operating condition.

4. The method according to claim 3, which further comprises carrying out an injection for the cylinders, for which an injection was omitted during the cylinder operating cycle, in a next cylinder operating cycle which immediately follows the cylinder operating cycle.

5. The method according to claim 1, which further comprises carrying out an injection with an increased fuel quantity out into the cylinders, for which an injection was omitted during the cylinder operating cycle, in a next cylinder operating cycle which immediately follows the cylinder operating cycle.

6. The method according to claim 1, which further comprises selecting freely a number of the cylinders and a sequence of the cylinders into which an injection is carried out or for which an injection is omitted.

7. The method according to claim 1, which further comprises selecting freely a fuel quantity to be injected for the cylinders into which an injection is carried out.

8. The method according to claim 1, which further comprises selecting the at least one predetermined operating condition to be an ambient temperature lying below a limit value, in a presence of which, injections into some of the cylinders are omitted in a directed manner during the at least one cylinder operating cycle.

9. The method according to claim 1, which further comprises selecting the at least one predetermined operating condition to be an injection pressure gradient lying below a limit value, in a presence of which, injections into some of the cylinders are omitted in a directed manner during the at least one cylinder operating cycle.

10. The method according to claim 1, which further comprises determining at least one of:
a number the cylinders into which an injection is carried out or for which an injection is omitted;
a sequence of the cylinders into which an injection is carried out or for which an injection is omitted; and
a fuel quantity to be injected for the cylinders into which an injection is carried out;
in dependence on the at least one predetermined operating condition.

11. An engine controller for an internal combustion engine having cylinders with direct injection of fuel, comprising:
an engine control device omitting injections into some of the cylinders in a directed manner during at least one cylinder operating cycle of the internal combustion engine after an event triggering an operation to start the internal combustion engine has occurred and in a presence of at least one predetermined operating condition.

12. An engine control device for an internal combustion engine having cylinders with direct injection of fuel, comprising:
means for omitting injections into some of the cylinders in a directed manner during at least one cylinder operating cycle of the internal combustion engine after an event triggering an operation to start the internal combustion engine has occurred and in a presence of at least one predetermined operating condition.

13. The engine control device according claim 12, wherein said means determines at least one of:
a number of the cylinders into which an injection is carried out or for which an injection is omitted;
a sequence of the cylinders into which an injection is carried out or for which an injection is omitted; and
a fuel quantity to be injected for the cylinders into which an injection is carried out;
in dependence on the at least one predetermined operating condition.
